(19) United States
(12) Patent Application Publication
(10) Pub. No.: US 2008/0184828 A1
(43) Pub. Date: Aug. 7, 2008

(54) Linear Actuator with a Redundant Structure

(76) Inventors: Pei-Yu CHEN, Taichung (TW); Bing-Hong Yang, Taichung (TW)

Correspondence Address: Dr. BANGER SHIA, 102 Lindencrest Ct., Sugar Land, TX, 77479-5201, US

(21) Appl. No.: 11/672,518

(22) Filed: Feb. 7, 2007

(51) Int. Cl. F16H 21/00

(52) U.S. Cl. 74/25; 74/89

(57) ABSTRACT

A linear actuator with a redundant structure comprises a motor, a gear box, a housing, a driving element and a follower element. An axis of the motor is protruded out of the linear actuator. When the linear actuator is stopped operation because of lacking power source, the linear actuator can be driven by rotating the axis, so as to solve the problem of unable to drive the linear actuator when lacking of electrical power.

### BACKGROUND OF THE INVENTION

1. Field of the Invention

The present invention relates to a linear actuator, and more particularly to a linear actuator with a redundant structure.

2. Description of the Prior Art

Referring to FIG. 1, a conventional linear actuator comprises a motor 10, a gear box 20, a housing 30 and a driving element 40. The motor 10 and the housing 30 are assembled in the gear box 20 respectively, and the driving element 40 is inserted into the housing 30. When the motor 10 rotates after being switched on, the driving element 40 will be driven by the motor 10 via the gear box 20.

However, since the motor 10 is driven by electrical power, once the power is off, the linear actuator and the driven mechanism will stop operation. At this time, the user has to disassemble the housing 30 and the outer casing of the gear box 20, in order to electrify the motor 10 with external electric power or to rotate the rotary shaft of the motor 10 with external force, otherwise the driving element 40 cannot be rotated. It is not only laborsome but also time consuming, and the linear actuator is likely to be damaged at the slightest carelessness.

Thereby, how to develop a linear actuator which can operate even in the case of a power outage has become an important issue for the manufacturers.

The present invention has arisen to mitigate and/or obviate the afore-described disadvantages.

### SUMMARY OF THE INVENTION

The primary objective of the present invention is to provide a linear actuator with a redundant structure which can be driven by external force by an axis of a motor protruded out of the linear actuator.

A linear actuator with a redundant structure comprises a motor, an axis of the motor is protruded out of the linear actuator. The linear actuator can be driven by rotating the axis, so as to solve the conventional problem of unable to drive the linear actuator when lacking of electrical power, and to avoid the inconvenience of disassembling the outer casing.

In addition, a follower element can be assembled to the protruded end of the axis, and cooperates with a tool to rotate the axis, so as to drive the linear actuator. The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a conventional linear actuator;

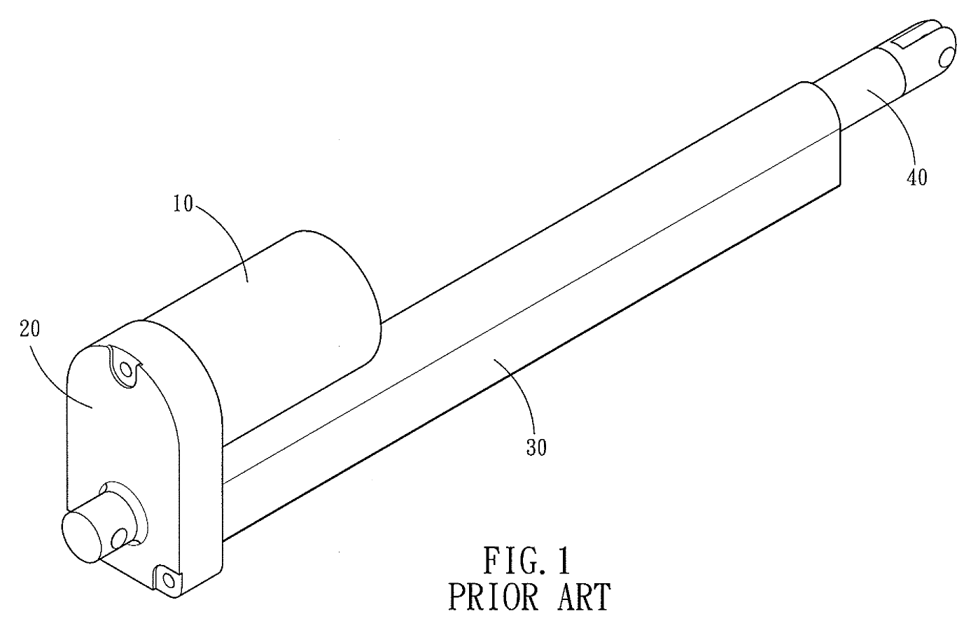

FIG. 2 is an assembly view of a linear actuator with a redundant structure in accordance with the present invention;

FIG. 3 is an assembly cross sectional view of the linear actuator with a redundant structure in accordance with the present invention;

FIG. 4 is a perspective view of the linear actuator with a redundant structure in accordance with the present invention;

FIG. 5 is an illustrative view in accordance with the present invention of showing the linear actuator being driven by external force; and

FIG. 6 is an illustrative view in accordance with the present invention of showing a follower element being passed through an axis of a motor.

### DETAILED DESCRIPTION OF THE PREFERRED EMBODIMENTS

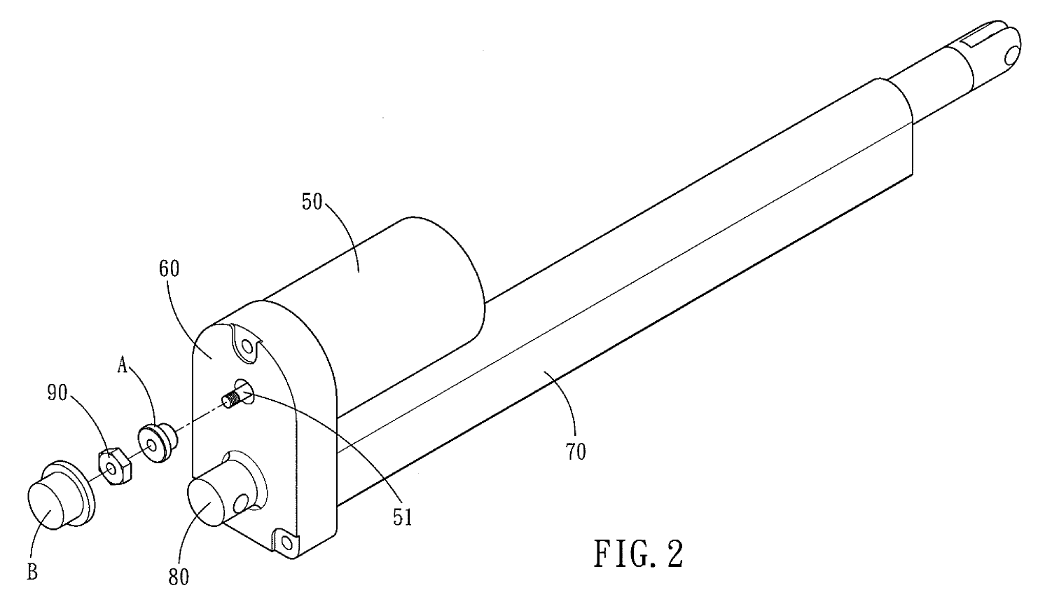

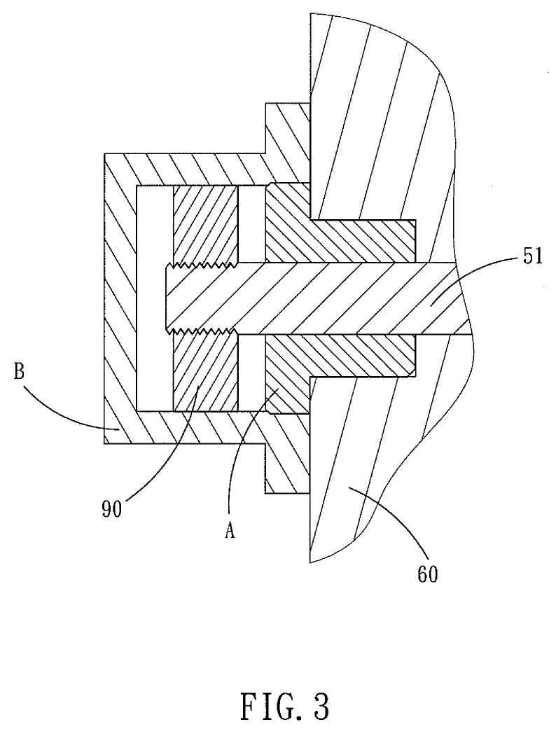

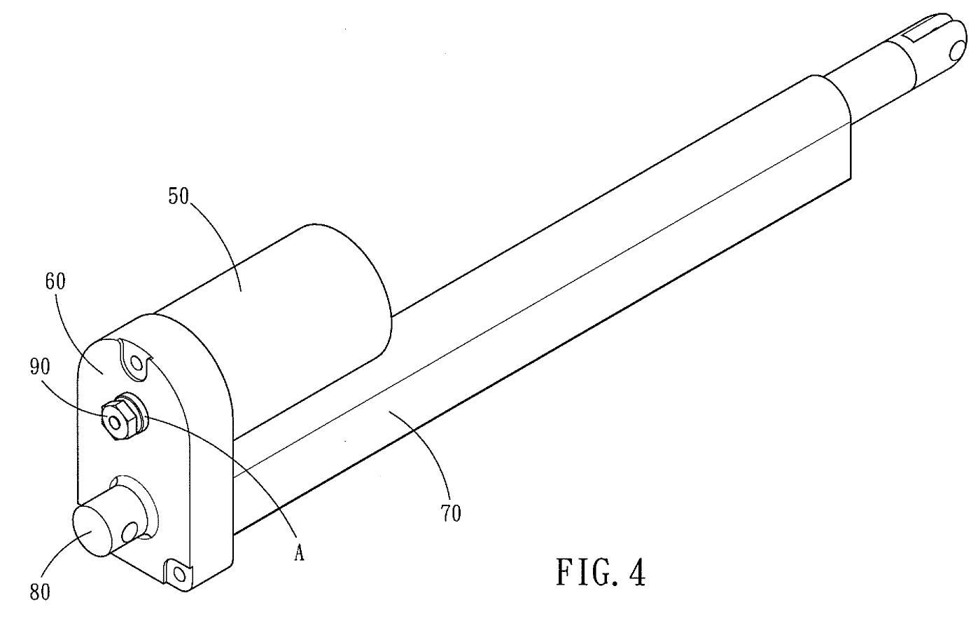

Referring to FIGS. 2-4, a linear actuator with a redundant structure in accordance with the present invention comprises a motor 50, a gear box 60, a housing 70, a driving element 80 and a follower element 90.

The gear box 60 is assembled to and driven by the motor 50, and an axis 51 of the motor 50 is protruded out of the gear box 60.

The housing 70 is assembled to the gear box 60.

The driving element 80 is inserted into the housing 70 and is driven by the gear box 60.

The follower element 90 is assembled to the axis 51 of the motor 50 and is protruded out of one end of the gear box 60, and in this embodiment, the follower element 90 is a nut.

In addition, a pad A can be further assembled to the gear box 60, and the axis 51 is passed through the pad A. The pad A is located between the follower element 90 and the gear box 60 for connecting to the axis 51, such that the axis 51 can be more stable when rotating.

The follower element 90 can be covered with a cover B for prevention of dust and water.

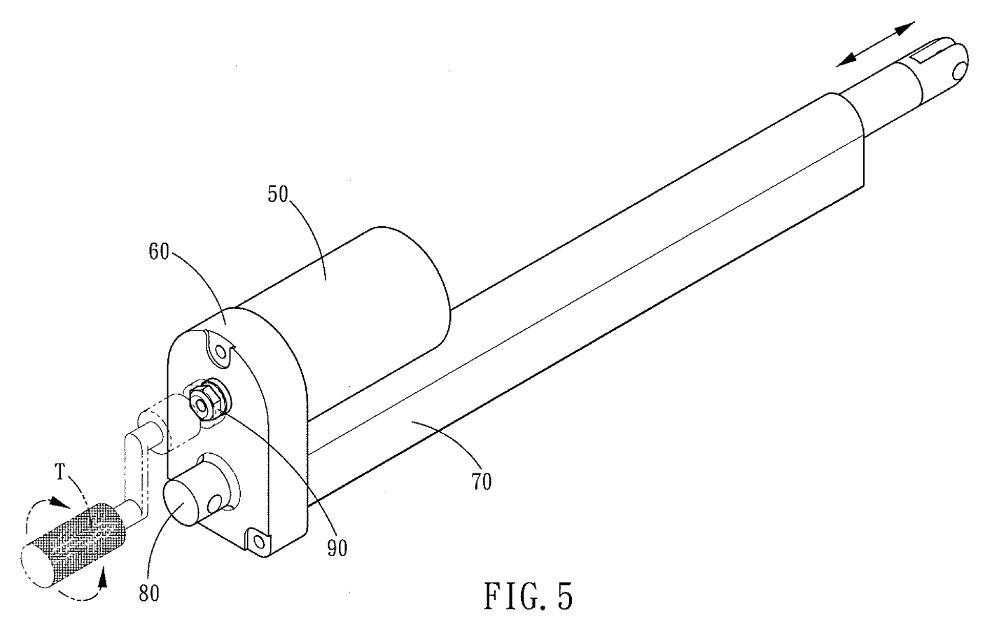

In normal conditions, the motor 50 of the present invention is driven by electrical power, and the gear box 60 is driven by the motor 50 to move the driving element 80, enabling the driving element 80 to move linearly in the housing 70 to rotate the driven mechanism. Referring to FIG. 5, if there is a power outage or the external power is cut off, the user can take off the cover B, and use a tool T to rotate the follower element 90, such that the axis 51 of the motor 50 will be rotated by the follower element 90 and to move the driving element 80 linearly in the housing 70, so as to obtain the purpose of driving the linear actuator by the external force.

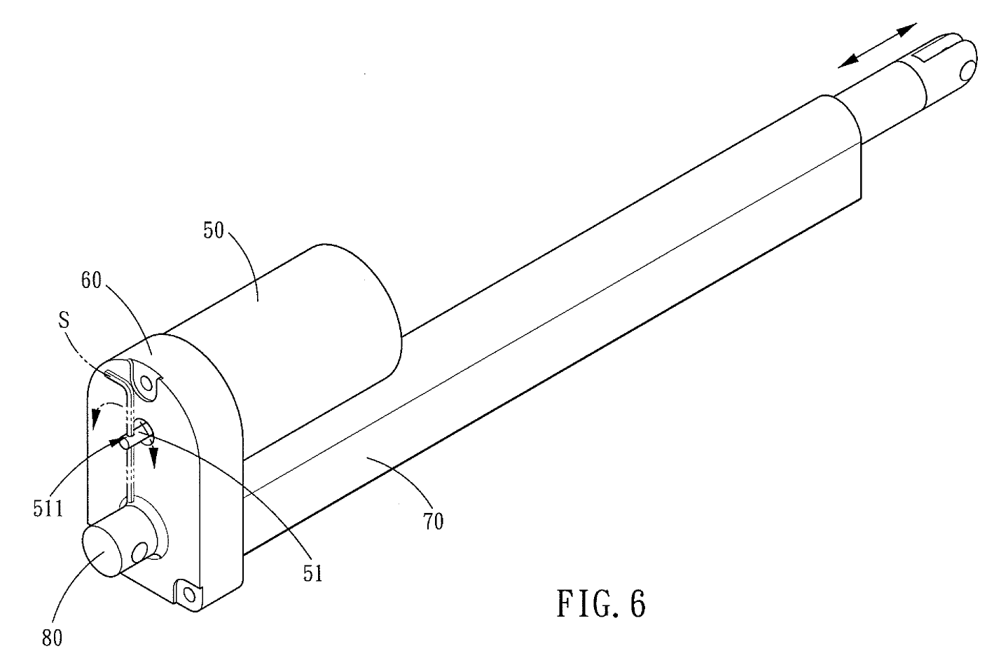

Further, the axis 51 of the motor 50 also can be rotated by the tool directly. For example, the protruded end of the axis 51 is defined with a through hole 511 for insertion of a tool S to rotate the axis 51 (as shown in FIG. 6). Or the protruded end of the axis 51 is a polygonal structure (such as square-shaped and hexagon), which is rotated by a suitable tool. Both of two methods can make the linear actuator operate and have the same effect as the follower element 90.

To summarize, a linear actuator with a redundant structure comprises a motor, an axis of the motor is protruded out of the linear actuator. When the linear actuator is stopped operation because of lacking power source, the linear actuator can be driven by rotating the axis, so as to solve the problem of unable to drive the linear actuator when lacking of electrical power.

While we have shown and described various embodiments in accordance with the present invention, it should be clear to those skilled in the art that further embodiments may be made without departing from the scope of the present invention.

What is claimed is:

1. A linear actuator with a redundant structure comprising an axis of a motor protruded out of the linear actuator for assembling a tool, and the axis of the motor being rotated by the tool.

2. The linear actuator with a redundant structure as claimed in claim 1, wherein a follower element is assembled to a protruded end of the axis.

3. The linear actuator with a redundant structure as claimed in claim 2, wherein the follower element is a nut.

4. The linear actuator with a redundant structure as claimed in claim 1, wherein a pad is assembled to the linear actuator, and the axis is passed through the pad.

5. The linear actuator with a redundant structure as claimed in claim 2, wherein a pad is assembled to the linear actuator, the axis is passed through the pad, and the pad is located adjacent to the follower element.

6. The linear actuator with a redundant structure as claimed in claim 3, wherein a pad is assembled to the linear actuator, the axis is passed through the pad, and the pad is located adjacent to the follower element.

7. The linear actuator with a redundant structure as claimed in claim 2, wherein the follower element is covered with a coven

8. The linear actuator with a redundant structure as claimed in claim 3, wherein the follower element is covered with a cover.

9. The linear actuator with a redundant structure as claimed in claim 5, wherein the follower element is covered with a cover.

10. The linear actuator with a redundant structure as claimed in claim 6, wherein the follower element is covered with a cover.
